(19) United States
(12) Patent Application Publication
(10) Pub. No.: US 2006/0015940 A1
(43) Pub. Date: Jan. 19, 2006

(54) Method for detecting unwanted executables

(76) Inventors: Shay Zamir, Nesher (IL); Yanki Margalit, Ramat-Gan (IL); Dany Margalit, Ramat-Gan (IL)

Correspondence Address: DR. MARK FRIEDMAN LTD.;C/o Bill Polkinghorn, 9003 Florin Way, Upper Marlboro, MD, 20772, US

(21) Appl. No.: 10/890,170

(22) Filed: Jul. 14, 2004

(51) Int. Cl. G06F 11/00

(52) U.S. Cl. 726/22

(57) ABSTRACT

The present invention is directed to a method for detecting unwanted executables and preventing the damage thereof, comprising: defining at least one API call as suspicious; scanning an executable for detecting suspicious API calls; and upon detecting a suspicious API call within said executable, either just determining said executable as unwanted or inspecting said executable. Following inspection, if said executable is indicated as unwanted and/or malicious, the damage thereof is prevented by eliminating the suspicious calls from said executable, discarding said executable, etc.

### FIELD OF THE INVENTION

The present invention relates to the field of detecting unwanted computer executables.

### BACKGROUND OF THE INVENTION

As the Internet becomes a major communication channel, it has also turned to be a channel for propagating “annoying” content. One of the known forms of annoying content is Spam, i.e. email messages that reach a user's email box, and usually contain advertising content.

The recent forms of annoying content are the adware, which cause advertising content to pop-up on the user's display while browsing the Internet, and the spyware, which tracks the browsing habits of a user and reports it to a remote site, in order to focus the content of advertising material, or even worse, to collect confidential information of a user.

In order to facilitate the reading of the description to follow, the following terms and acronyms are explained:

The term “unwanted content” refers herein to content that a user may be exposed to, against his will. Annoying content is an example of unwanted content.

The term “unwanted executable” refers herein to an executable (program, script, etc.) that causes exposure of a user to unwanted content, whether directly (e.g. by displaying unwanted content) or indirectly (e.g. by changing the default home page address of a browser).

There are a variety of ways to propagate unwanted objects (content and/or executables). For example, while browsing the Internet, a user's computer is exposed to installation of unwanted objects, even without the user being aware of it. Moreover, installation of unwanted objects within a user's computer may be carried out by his acceptance and collaboration. For example, a user that installs on his computer a shareware or freeware program usually selects the defaults of the installation, especially if he is not a computer specialist. During the installation he may be asked if he would like to receive further information, and since he usually selects the default option, an adware program can be installed on his computer.

There are a variety of means that cause displaying of unwanted content. For example, programs that are executed when the operating system starts up can be used for this purpose; the default homepage of a Web browser can be used as a means for indirectly displaying unwanted content; a browser toolbar can also be used for displaying unwanted content; an installation procedure can also be used for installing unwanted executables; and many other ways.

Usually unwanted objects cannot be considered as “viral”, since they do not multiply themselves, and also do not harm the user's computer. Consequently the known methods of detecting viral presence, such as virus signatures, may be less effective for detecting unwanted objects.

It is an object of the present invention to provide a method for detecting unwanted executables.

It is another object of the present invention to provide a method for detecting unwanted executables, in which the detection can be carried out in a virtual platform.

It is a further object of the present invention to provide a method for detecting unwanted executables, by which spyware, adware, operating system startup executables, and so forth can be detected.

Other objects and advantages of the invention will become apparent as the description proceeds.

### SUMMARY OF THE INVENTION

In one aspect, the present invention is directed to a method for detecting unwanted executables (e.g. spyware, adware, viral executable, malicious executable, etc.), the method comprising the steps of:

defining at least one API call as suspicious;

scanning an executable for detecting suspicious API calls; and

upon detecting a suspicious API call within the executable, determining the executable as an unwanted executable.

The suspicious API call may refer to a certain API function, a certain parameter of an API function, and a certain API function with at least a certain parameter.

The API function may have relevance to registry access, registry update, startup of an operating system, homepage of a Web browser, dialing, communication, file system, Internet browser, user interface, and so forth.

The scanning may be carried out on a real platform or a virtual platform.

The method may further comprise sterilizing the executable and/or discarding the executable.

In another aspect, the present invention is directed to a method for detecting unwanted executables (e.g. spyware, adware, dialer, key logger, listener, viral executable, malicious executable, etc.) and preventing the damage thereof, the method comprising the steps of:
defining at least one API call as suspicious;
scanning an executable for detecting suspicious API calls; and
upon detecting a suspicious API call within the executable, inspecting the executable.

The suspicious API call may be a certain API function, at least a certain parameter of an API function, and a certain API function with at least a certain parameter.

The API function has relevance to a member of a group comprising: a registry access, a registry update, startup of an operating system, homepage of a Web browser, dialing, communication, file system, Internet browser, user interface, and so forth.

The scanning may be carried out on a real platform or a virtual platform.

The executable may be a readable object, a compiled object, etc.

Inspecting may be carried out in order to indicate if the executable is malicious and/or unwanted.

The method may further comprise: upon indicating the executable as unwanted and/or malicious, discarding the executable.

The method may further comprise: upon indicating the executable as unwanted and/or malicious, sterilizing or discarding the executable.

### BRIEF DESCRIPTION OF THE DRAWINGS

The present invention may be better understood in conjunction with the following figures:

FIG. 1 schematically illustrates a system that may be used for implementing the present invention.

FIG. 2 is a flowchart of a process for detecting unwanted executables, according to a preferred embodiment of the invention.

FIG. 3 is a flowchart of a process for detecting unwanted executables, according to another preferred embodiment of the present invention.

### DETAILED DESCRIPTION OF PREFERRED EMBODIMENTS

In the art, the term gateway refers to a network point that acts as an entrance to another network. As such, a gateway is a suitable point for filtering unwanted objects.

A system that provides the connectivity between the two networks is referred in the art as a gateway server. From the implemental point of view, a gateway server is often associated with both a router, which knows where to direct a given packet of data that arrives at the gateway and a switch, which furnishes the actual path in and out of the gateway for a given packet. The connectivity can be carried out at any level of the OSI model, from application protocols to low-level signaling. Because a gateway by definition appears at the edge of a network, related functionality like fire-walling tends to exist at the same location.

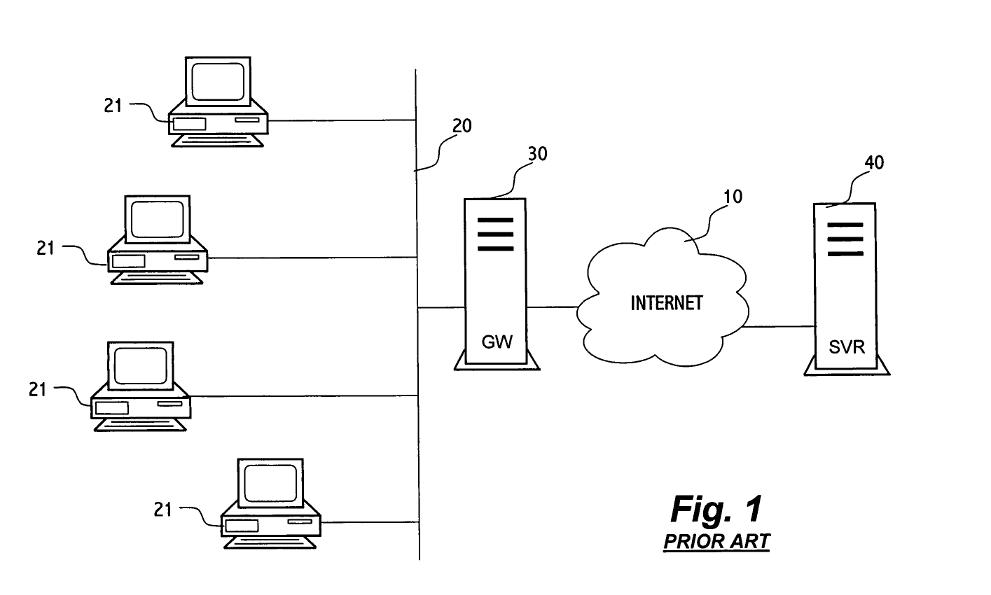

FIG. 1 schematically illustrates a system that may be used for implementing the present invention. The computers 21 are connected to the local area network 20. The local area network 20 is connected to the Internet 10. The gateway server 30 is interposed between the local area network 20 and the internet 10. The internet server 40 hosts Web sites. A browser being executed on a computer 21 that addresses the Web site hosted by the Internet server 40 cause files to be transferred from the Internet server 40 to the computer 21 through the gateway server 30. The transferred file can be inspected on a real platform, i.e. on the user's computer, or on the virtual platform, e.g. the gateway server 30.

In terms of real/virtual platforms, the computer 21 is a real platform, and the gateway server 30 may be implemented as a virtual platform.

The conditions of inspecting executables on a virtual platform are substantially different than the conditions of inspecting executables on a real platform. Firstly, a virtual platform has to deal with a great amount of executables that passes through it at any given moment, contrary to a real platform which deals with individual executables. Also it is not practical to execute each suspicious executable on a virtual platform, in order to track its behavior. Moreover, executables may be designed to interact with a user, and it is not practical to employ a human factor on a virtual platform to interact with every suspicious executable.

As such, the methods for inspecting executables on a gateway usually differ from the methods used for inspecting executables on a personal computer.

Inspection, i.e. detection of unwanted and malicious objects, is usually carried out on one of two platforms: (a) on a real platform, i.e. on the user's computer; and (b) on a virtual platform, i.e. any computer but not the user's computer, in order to prevent possible damage to the user's computer. A real platform provides more possibilities to monitor the executable, thereby to detect unwanted objects, but a virtual platform provides a shield, since unwanted objects can be stopped before reaching a user's computer.

The term API (Application Program Interface) refers in the art to a set of routines, protocols, and tools (referred herein also as API functions) for causing a first program to be operated by another program. Consequently the first program can be treated as a “black-box” which interacts with the outside world by API functions. For example, operating system services can be activated by application programs via dedicated API functions.

The term “API call” refers herein to code for invoking an API function, parameter(s) of an API function, code for invoking an API function with certain parameter(s), etc.

“Dialer” is a common nickname for a program which reroutes a user's Internet connection through a high paid telephone number. A user that connects to the Internet through a dial-up connection may be rerouted by a Dialer to a high paid number instead of his regular connection, and consequently his telephone account gets charged for telephone calls that he has not intended to do, usually at a high cost. From the technical point of view, under the Windows operating system, a Dialer uses API calls of the MODEM API module. Thus, an executable program may be classified as suspicious if it calls to certain MODEM API functions. Moreover, an executable program can be identified as Dialer by the existence of a combination of a certain MODEM API call with a known high paid telephone number as parameter.

“Key loggers” are programs that record a list of key strokes carried out by a user while typing, and send it via the Internet to a hostile object. The list of key strokes (known as “log”) can be used for detecting passwords, credit card numbers etc. From the technical point of view, key loggers use a certain type of API, which is known as “Hooking API”. Thus, a program that uses function of the Hooking API is suspicious, especially if the call is with certain value of its parameters.

“Listeners” are programs that open a “back door” to the user's computer by “listening” to some TCP/IP port. Listeners can be detected by looking for a certain API usage of the windows socket API. Such a use of API calls can be carried out also due to a legitimate reason. Thus, it is up to the user or network administrator to decide whether such a use is valid for a certain program.

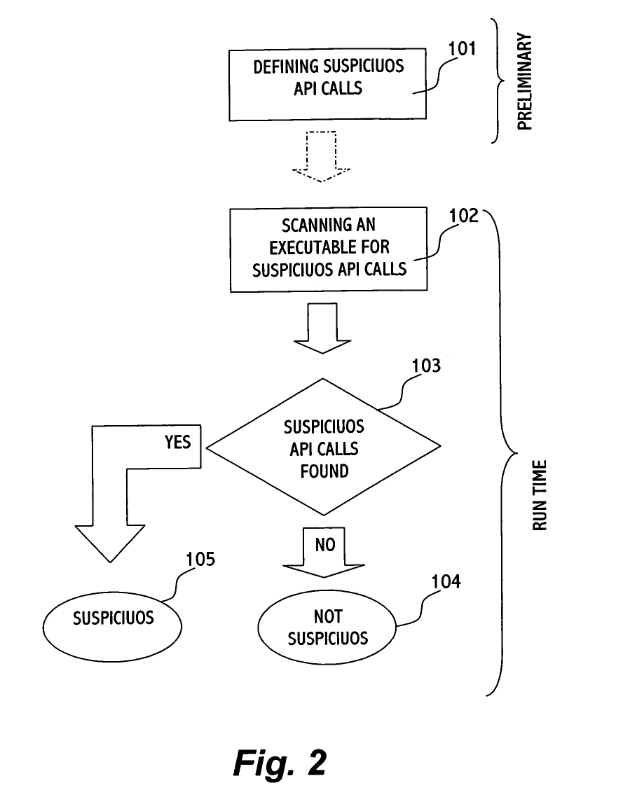

FIG. 2 is a flowchart of a process for detecting unwanted executables, according to a preferred embodiment of the present invention.

The process is divided into two parts: a preliminary stage, and a run time stage. In the preliminary stage, at block 101, a group of suspicious API calls is defined. A definition of a suspicious API call can be a call to a specific API function, a call to any API function with specific parameter(s), a combination of both, i.e. a call to a specific API function with specific parameter(s), and so forth.

In run time, at block 102, when an executable reaches the gateway, it is scanned for API calls, and those API calls found are compared against the list of suspicious API calls. From block 103, if a suspicious API call has been found in the executable, then the executable is considered to be suspicious, as indicated in block 105, otherwise the executable may be considered as unsuspicious, as indicated by block 104.

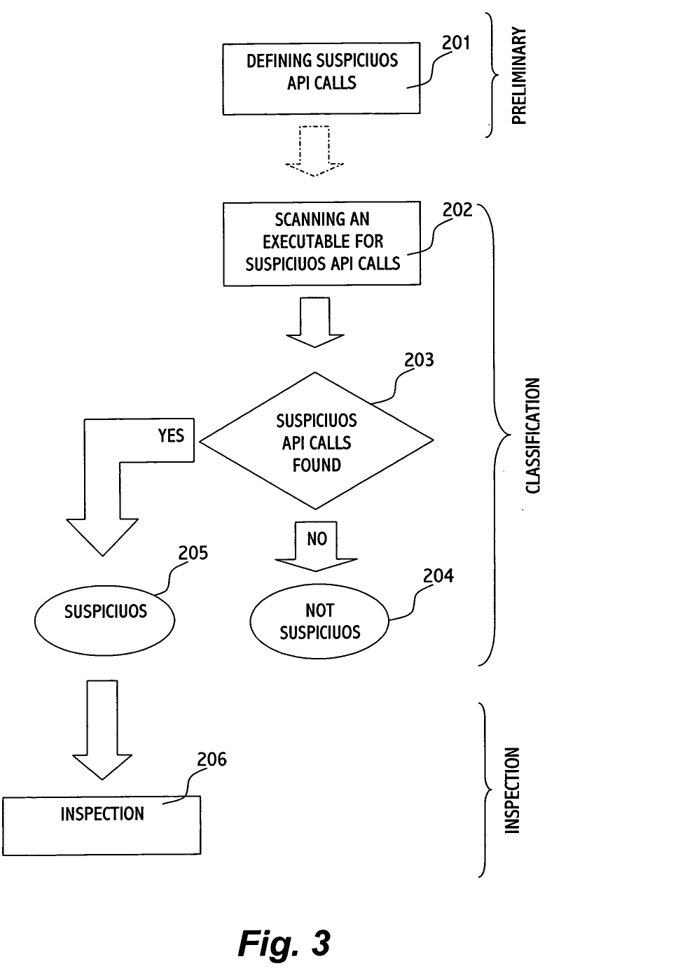

FIG. 3 is a flowchart of a process for detecting unwanted executables, according to another preferred embodiment of the present invention.

The process is divided into three parts:
A preliminary stage, in which a group of API functions are determined as suspicious: At block 201, a group of suspicious API calls is defined. A definition of a suspicious API call can be a call to a specific API function, a call to any API function with specific parameter(s), a combination of both, i.e. a call to a specific API function with specific parameter(s), and so forth.
A classification stage, in which an executable is classified as suspicious or unsuspicious: At block 202, when an executable reaches the gateway, it is scanned for API calls, and the found API calls are compared against the list of suspicious API calls. From block 203, if a suspicious API call has been found in the executable, then the executable is considered to be suspicious, as indicated in block 205, otherwise the executable may be considered as unsuspicious, as indicated by block 204.
An inspection stage, in which a suspicious executable is further inspected for classifying the executable as unwanted and/or malicious, as indicated in block 206.

The classification stage is used for classifying an executable as suspicious or unsuspicious, and the inspection stage is used for inspecting a suspicious executable, usually by more intensive inspection tests.

In other words, in the classification stage, a rough estimation of the possibility of existence of suspicious calls can be indicated, in order to decide if the inspected executable should be further inspected by more intensive tests. The inspection stage according to its nature may be slower than the first inspection stage however it can be more effective. Furthermore, the intensive inspection can be used for detecting other forms of unwanted content.

Detecting API calls within an executable such as Windows EXE and JAVA can be carried out, for example, by a simulation engine. In this method, the execution code is scanned, and the simulation engine “performs” the actions set by the scanned code on its internal data, simulating the operation of the CPU and the operating system. When the executed code performs a call to an outside DLL or COM object, the function name and parameters are compared to a known set of suspicious functions and parameters upon which the code is indicated as suspicious or unsuspicious.

Another method for detecting function calls is by disassembly. In this case, code bytes are scanned, identified and translated into code lines. The code lines are analyzed in order to detect patterns of API calls. Found API calls are cross referenced into actual API destinations. According to this method, no execution or simulation is required, and therefore it is faster than a simulation method. This method is not effective for detecting encrypted parameter values or dynamically created parameters.

In the Microsoft Windows operating systems, a registry is a database that stores information about the configuration of the operating system, installed applications, attached hardware, optional components such as ODBC, what system options have been selected, how the computer memory is set up, what application programs are to be present when the operating system starts, the association between a file extension and applications, and so forth.

The registry is somewhat similar to and a replacement for the INI files and configuration files used in earlier Windows systems and DOS-based systems. INI files are still supported by the recent versions of Windows, however, usually for compatibility with 16-bit applications written for earlier systems.

Calling registry related functions is very common and by itself does not denote malicious intent. On the other hand, a combination of a call to a registry related function with certain parameters (such as an attempt to write into a registry entry that specifies the programs that run during booting the computer) may indicate maliciousness.

The following functions are examples of Windows API functions for accessing the registry of a computer:
RegReplaceKey (hKey, sSubKey, sNewFile, sOldFile) Which allows replacing an entire hive when the system is next booted.
RegRestoreKey (hKey, sFileName, uFlags) Which reads in a hive file and copies its content over an existing registry tree.

For example, RegCreateKey and RegReplaceKey may appear in several variations. They also can be called by their ordinal number. A simulation can detect a call to these functions and the parameter values used for the call. The use of a registry is very common in Windows applications and does not denote a malicious intent by itself, but in combination with certain parameter values supplied by a calling process. For example, an attempt to replace the content of a registry entry that specifies the programs executed during the boot procedure can “turn a red light on”. According to one embodiment of the invention, if this call is carried out with a parameter that comprises a known malicious program name or URL, the executable can be classified as malicious, and the damage thereof can be prevented.

Typically, unwanted executables, such as spyware and adware, use the registry for retrieving information about the user's computer, which programs are executed at a given moment, which Web sites have been browsed recently, and so forth. Based on such information, an adware application may pop-up a window with certain advertising content, and a spyware application can retrieve sensitive information such as credit card numbers, and send it to a hostile object.

The Internet Explorer browser, manufactured by Microsoft, also provides an API, upon which the way the browser operates can be directed. For example, it is possible to instruct the browser to open a new window for a certain URL (Uniform Resource Location, i.e. an address that defines the route to a file on the Web or any other Internet facility). Thus, if an executable comprises a call to an API function that opens a new window of a known advertising URL, then the program can be classified as adware.

According to one embodiment of the invention, a suspicious executable is discarded. According to another embodiment of the invention the code of the executable is amended such that the suspicious API calls are removed or bypassed (“sterilized”).

The discussion herein is directed mainly to executable code which usually cannot be detected by virus detection methods, such as virus signatures. However it should be noted that the disclosed method can also be implemented with any form of executable, regardless to their object, including malicious executables. Thus, although the term “unwanted executable” was defined above by its object (preventing exposure of a user to unwanted content), it should be noted that the disclosed method may be implemented for any executable regardless of its object.

It should be noted that although the reference and examples herein refer to a registry, the term registry is directed also to other forms of databases for this purpose, such as INI files.

It should also be noted that an executable may be either a compiled object (e.g. Windows EXE) or a readable object (e.g. JavaScript).

Those skilled in the art will appreciate that the invention can be embodied by other forms and ways, without losing the scope of the invention. The 5 embodiments described herein should be considered as illustrative and not restrictive.

1. A method for detecting unwanted executables, the method comprising the steps of:
defining at least one API call as suspicious;
scanning an executable for detecting one of said at least one suspicious API call; and
upon detecting said one suspicious API call within said executable, determining said executable as unwanted executable.

2. A method according to claim 1, wherein said at least one suspicious API call is selected from the group comprising: a call of a certain API function, a call of an API function that includes at least one certain parameter, and a call of a certain API function with at least one certain parameter.

3. A method according to claim 2, wherein said at least one API function has relevance to a member of a the group comprising: a registry access, a registry update, a startup of an operating system, homepage of a Web browser, dialing, communication, a FAT, an Internet browser, a user interface.

4. A method according to claim 1, wherein said scanning is carried out on a real platform.

5. A method according to claim 1, wherein said scanning is carried out on a virtual platform.

6. A method according to claim 1, wherein said unwanted executable is selected from the group comprising: spyware, adware, a dialer, a key logger, a listener, a viral executable, a malicious executable.

7. A method according to claim 1, wherein said executable is selected from the group comprising: a readable object, a compiled object.

8. A method according to claim 1, further comprising the step of sterilizing said executable

9. A method according to claim 1, further comprising the step of discarding said executable.

10. A method for detecting unwanted executables and preventing the damage thereof, the method comprising the steps of:
defining at least one API call as suspicious;
scanning an executable for detecting one of said at least one suspicious API call; and
upon detecting said one suspicious API call within said executable, inspecting said executable.

11. A method according to claim 10, wherein said at least one suspicious API call is selected from the group comprising: a call of a certain API function, a call of an API function that includes at least one certain parameter, and a call of a certain API function with at least one certain parameter.

12. A method according to claim 11, wherein said API function has relevance to a member of a group comprising: a registry access, a registry update, startup of an operating system, homepage of a Web browser, dialing, communication, FAT, Internet browser, user interface.

13. A method according to claim 10, wherein said scanning is carried out on a real platform.

14. A method according to claim 8, wherein said scanning is carried out on a virtual platform.

15. A method according to claim 10, wherein said unwanted executable is selected from the group comprising: spyware, adware, a dialer, a key logger, a listener, a viral executable, a malicious executable.

16. A method according to claim 10, wherein said executable is selected from the group comprising: a readable object, a compiled object.

17. A method according to claim 10, further comprising the step of sterilizing said executable.

18. A method according to claim 10, wherein said inspecting is carried out for indicating if said executable is malicious.

19. A method according to claim 10, wherein said inspecting is carried out for indicating if said executable is unwanted.

20. A method according to claim 10, further comprising the step of: upon indicating said executable as unwanted, discarding said executable.

21. A method according to claim 10, further comprising the step of: upon indicating said executable as malicious, discarding said executable.

22. A method according to claim 10, further comprising the step of: upon indicating said executable as unwanted, sterilizing or discarding said executable.

23. A method according to claim 10, further comprising the step of: upon indicating said executable as malicious, sterilizing or discarding said executable.
